(19) United States
(12) Patent Application Publication
(10) Pub. No.: US 2020/0265521 A1
(43) Pub. Date: Aug. 20, 2020

(54) MULTIMEDIA RISK SUMMARIZER

(71) Applicant: AMARIS.AI PTE. LTD., Singapore (SG)

(72) Inventors: Khue Hiang CHAN, Singapore (SG); Chien Siang YU, Singapore (SG)

(21) Appl. No.: 16/792,306

(22) Filed: Feb. 17, 2020

Related U.S. Application Data
(60) Provisional application No. 62/805,975, filed on Feb. 15, 2019.

(51) Int. Cl. G06Q 40/06; G06Q 10/10; G06N 20/00

(52) U.S. Cl. CPC G06Q 40/06; G06N 20/00; G06Q 10/10

(57) ABSTRACT

A system and method for an AI risk summarizer are disclosed. Risk assessment includes receiving instream data from different data sources and processing the instream data to extract informative features. Risk analytics is computed using extracted informative features and results may be generated as reports to include multimedia reports. Overall, the system and method support multimedia data processing for a more meaningful and accurate risk assessment.

### CROSS-REFERENCE TO RELATED APPLICATION

This application claims the benefit of U.S. Provisional Application No. 62/805,975, filed on Feb. 15, 2019, which is incorporated herein by reference in its entirety for all purposes.

### FIELD OF THE INVENTION

The present disclosure relates to a risk summarizer for market risk assessments. In particular, the present disclosure relates to a risk summarizer for operational market risk assessments using artificial intelligence (AI) configured to support multimedia processing with comprehensive 4D analysis views.

### BACKGROUND

Financial markets are fraught with risks, due to inherent uncertainties and volatility associated with the increasingly complex global environment in which they operate. A risk may be defined as a likelihood that an event will occur and adversely affect achieving an objective. A risk may be quantified as impact times probability. For example, a probability of an event occurrence is multiplied by the impact of the event. Risks can arise from various sources. For example, risks can arise from sources which are internal and external to the financial markets. Internal market risks may include interest rate risk, equity risk, currency risk and commodity risk. As for external risks, they may include political turmoil, changes in regulatory frameworks, natural causes, cybercrime and terrorist attacks.

A fundamental difficulty in risk evaluation or assessment is a lack of reliable statistical information due to the infrequent nature of many types of adverse events. In addition, evaluating an impact or risk is not always straightforward for intangible assets. As such, key sources of information have to include both available statistics and best-educated opinions. Risk management may include the identification and characterization of threats, calculation of vulnerability of critical assets to specific threats, evaluation of expected likelihood and impact of specific events on respective classes of assets, identification of approaches to reduce the risks as well as the prioritization of risk reduction measures in order to timely coordinate and apply resources to either mitigate, survey and control the likelihood or severity of adverse events or to maximize the realization of opportunities. It is worth noting that the Basel II framework has adopted a requirement for a formal risk modeling to be conducted by all major international financial institutions and enforced by their national regulators.

The difficulty in risk assessment is further exacerbated by the tedious traditional methods of risk analysis which require periodic and systematic data gathering and risk evaluation against predefined hazards and vulnerabilities. At present, a vast majority of risk models are still spreadsheet-based. The reason for this is largely due to the fact that risk evaluation processes are nearly always conducted at an institution-specific level. As the global economy becomes increasingly more decentralized, diversified and disruptive, it is even harder to constantly generate progressive risk assessments that can keep up with a dynamic and fast-changing financial market. This is especially so when the process is still carried out either manually by Finance/Risk Officers or by information technology (IT) systems.

Therefore, from the foregoing discussion, there is a desire to provide methods and systems which effectively assess market risks despite market dynamics and new regulatory requirements.

### SUMMARY

Embodiments generally relate to market risk assessments. In particular, the embodiments relate to operational market risk assessments using AI configured to support multimedia processing with comprehensive 4D analysis views.

In one embodiment, a method for market risk assessment includes receiving instream data from different data sources and processing the instream data. Processing the instream data includes identifying one or more content types in the instream data and extracting features from the one or more content types to form a multivariate dataset. The method further includes computing risk analytics using the multivariate dataset and generating results of risk analytics as reports including multimedia reports. The processing is configured to provide multimedia processing for a more meaningful and accurate risk assessment.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows an overview of an embodiment of a system architecture of an AI risk summarizer system;

FIGS. 2a-c show various exemplary processes of an embodiment of a system architecture of an AI risk summarizer system;

FIG. 3 shows an exemplary computational process by an AI finance-compute engine; and

FIG. 4 shows various screenshots of exemplary outputs.

### DETAILED DESCRIPTION

Embodiments described herein generally relate to a risk summarizer for market risk assessment. In particular, methods and systems of an Artificial Intelligence (AI) risk summarizer for operational market risk assessment configured to support multimedia processing for risk evaluation with comprehensive 4D analysis views.

As such, the risk summarizer system is highly automated and based on AI. The risk summarizer is configured to be multimedia capable, self-learning and self-configuring. For example, the risk summarizer is a unified and automated model of a business process with built-in risk assessment. The model serves as an early warning system, with multiple input sensors and event detection subsystems to provide real-time market analysis. The model, for example, includes retrieving and aggregating records of interest, automatically evaluating current levels of each of a multitude of market risk factors, assessing relevance of those factors and displaying risk indicators.

The risk summarizer system may be framed as a supervised AI, machine learning (ML) and/or deep learning (DL) model, which is trained to predict the price action or movement probabilities using complex multivariate and multi-step time series. For example, a key input for the model, for each asset in a multi-asset portfolio, may be the uni/bi-variate time series in the numeric format. Such inputs may include, for example, the price of a company share, commodity, housing stock, currency exchange pair or cryptocurrency and volume traded. The inputs provide the essential independent variables, such as the past and the present value, the so-called model features, and the dependent/target variable(s), such as the future values of the asset, from which short time trends in price action may be analyzed. In addition, cyclical trend indicators over a desired time frame can be easily feature-engineered from this time series, such as commodity channel (CCI), money flow (MFI) and relative strength (RSI) indices in the case of equities, commodities and currencies.

The multivariate nature of the time series may be achieved by combining multimedia data with numeric data as sources of signals of the price action and the associated risk. For example, the risk summarizer is configured to process instream data containing different types of data, including multimedia and numeric data types. Furthermore, multimedia may include different content types. For example, the different content types may include text and numerical content, graphical content, image content, animations content, audio content or any other content types. The processing, in one embodiment, may include employing Natural Language Processing (NLP) and image recognition units to parse and extract meaningful data from the instream data. For example, the meaningful data may include numeric features and non-numeric features to form multivariate datasets.

A human operator may define a set of Internet multimedia data sources. For example, a human operator may define a set of data sources, enabling the risk summarizer to collect a comprehensive set of data from diverse sources to generate a more reliable risk assessment. For example, in the case of commodities, it will be useful to combine numerical data, such as internal financial reports, together with multimedia data, such as weather reports since the weather affects natural resources and can have a profound effect on the industry.

An example of sources and processing of numerical and multimedia data is provided. For example, regularly updated numeric trading data can typically be accessed in forms of spreadsheets from many finance Web sites, such as Google and Yahoo Finance. The risk summarizer system, having both NLP and image recognition capabilities, dynamically links the holdings in a portfolio as well as providing recommendations as assets to consider for acquisition with the sources of multimedia data. Furthermore, from seasonal statements, news releases, reports, outlooks and guidance, published by monetary authorities, financial institutions and/or economic forecasters in either plain text or portable document format (PDF), additional numeric features may be identified by an NLP-enabled entity extraction. The same set of documents may also serve as a main source of categorical data for an NLP-enabled sentiment analysis. In the case of charts and plots, such as a summary of the market open positions for securities, commodities or currencies, structured numeric data can be readily extracted using of-the-shelf tools, such as SnapCharts, and added as additional features to the data set. Similarly, numeric data can easily be extracted from tables in the relevant portable document format (PDF) records, for example, using the Camelot library or other similar tools. To extract non-numeric features, for example, from Internet forums, Web news articles, audio and/or video streams, sentiment analysis can be routinely conducted by converting speech to text, and deploying a ML/DL NLP-pretrained subsystem on the text to output opinions as additional categorical features with either positive, negative or neutral values. Video formats may be resolved into separate frames and inspected by an image recognition subsystem to extract the charts, plots and tables and numbers. In the case of commodities, regular weather reports are NLP-processed as a source of important data, since the weather can have a profound effect on both mineral (for example, adversely affecting extraction operations in the mines) and agricultural (for example, extreme weather decimating the crops) commodities. The weather data is processed both at commodity source and along major shipping routes, since adverse weather can disrupt a distribution chain and cause price fluctuations. Related to the distribution chain, automatic identification system (AIS) data, which may be supplemented by a satellite imagery, of shipping vessel traffic can be processed to augment the data on the commodity volume trade, demand and supply.

In one embodiment, the system utilizes an AI finance-compute engine to compute risk assessment using the multivariate datasets. By using AI computational techniques to train the finance-compute engine, the system provides for a wide range of analysis methods. For example, an analysis method includes using univariate, bivariate, multivariate analysis or other types of analysis. Additionally, AI classification techniques such as binary classification, multiclass classification, linear regression or non-linear regression may also be employed.

In one embodiment, the system is configured to provide risk assessment outputs in different formats. The different formats may include conventional risk reports with risk scores and findings, as well as multimedia risk reports such as videos or 4-dimensional (4D) visualization displays.

A core AI operational system manages all AI-driven processes, including processing of instream data and risk assessment requests from users, computing of risk models, generating risks reports as output data, are carried out in a single streamlined process. This process allows collection of data from diverse sources and yet simplifies the complexity of retrieving meaningful data for generating 4D analysis output. At the same time, the system provides a risk assessment workflow that is able to conduct highly complex and adaptable market evaluations to meet the demands of a dynamic financial market.

The risk summarizer system is also configured to continually learn and identify fake news and reports, fake AI-generated images and videos which are produced to potentially spook off, manipulate and distort the markets. The system identifies such documents based on audio signal processing, keywords and linguistic features that exhibit strong bias or misinformation, for example, by using a hyperbolic language, and web traffic (considering that fake news tends to attract a lot of attention).

Prior to deployment of the system, the system is trained using a same set of features from historic data, which is split into training, validation and testing sets. The training ensures that the risk summarizer is capable of assessing risks based on, for example, a multi-step price action forecast. For example, the risk summarizer goes through ML/DL model training for the multivariate time series analysis.

In some cases, a target variable for the risk assessment may be probabilities of price action instead of absolute asset price movement. The probability may be expressed in binned percentages over a time period, such as the probability that it moves up/down 0-10%, 10-20%, or >20%. That is, rather than training a multivariate non-linear regression ML/DL model, a multiclass classification model is employed, based on the predicted probabilities, and accept the scenario with the highest probability as most likely. Both the up and down expectations of price movement are flagged as opportunities. For example, opportunities may be to hold/acquire (up expectation) or sell/short (down expectation) the asset. In the case of credit risk, where the object of risk modeling is not an asset, but an institutional/individual client, the problem is simply framed as binary classification, completely analogous to predictive maintenance from multivariate time series, where the risk is evaluated from the output probability of the client failing to meet their obligations, such as defaulting on payments. Finally, for each asset/client, the standard feature importance analysis produces the most decisive risk factors.

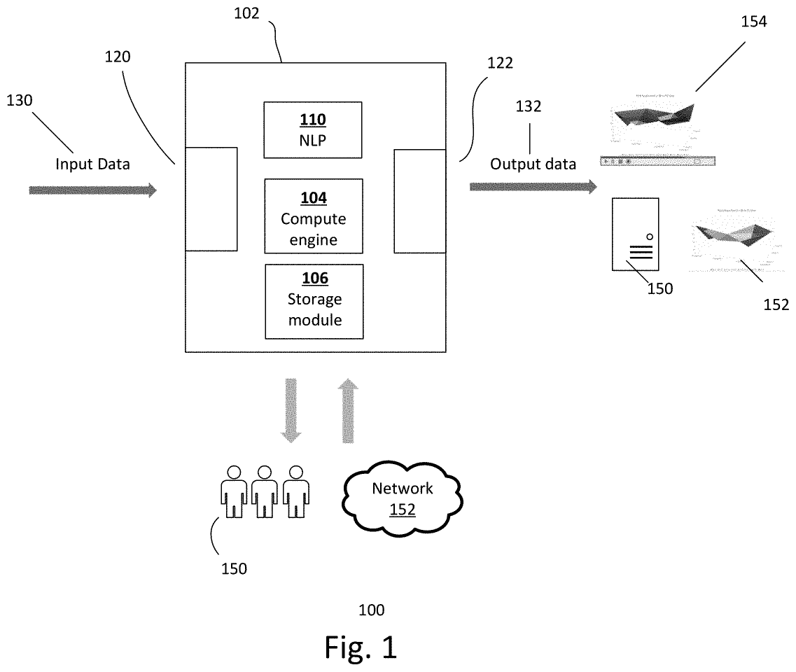

FIG. 1 shows an overview of an embodiment of a system architecture of an AI operational risk assessment or risk summarizer system 100. The system 100 may include one or more components, modules or layers, which may be implemented using software and/or hardware, optionally across multiple locations or using multiple devices or units.

Referring to FIG. 1, the risk summarizer system 100 includes a processing module 102, an AI finance-compute engine module 104, and a data storage module 106 communicatively coupled to one another.

In one embodiment, the processing module is configured to manage incoming or outgoing data. The processing module includes input 120 and output 122 platforms. The input platform 120 receives input or instream data 130. Instream data may include, for example, financial reports, exchange filings, news releases, weather reports, satellite images as well as any other types of data sources. The instream data may be received in a native format of a recipient. As such, different instream data may include different native formats. The system 100 facilities handling of high velocity and huge volumes of data. In one embodiment, the input platform is configured to receive instream data from numerous sources. The numerous sources, for example, may include the Internet, forums, discussions, blogs, tweets or any other available sources. The input platform, in one embodiment, may be configured to receive instream data from numerous sources and process them in parallel.

In one embodiment, a user 150 may define a set of instream data to be collected by the system. For example, the system may include frontend components to facilitate running on a client device associated with a user. The client device can be any manner of computer or computing device with, for example, local memory and processor, or even a mobile computing device, such as a smartphone and/or laptop. In practice, a user may download a frontend system to a client device associated with the particular user 151 as a computer application (App). An interface module of the App presents information output for display on a screen of the client device and allows the user to navigate the system 100 and interact with the components, modules, layers or digital content therein. For example, the interface module allows a user to define and select a set of sources from which data is collected and processed by the AI risk summarizer system for risk evaluation. Alternatively, data from any available sources can be automatically streamed into the AI risk summarizer system via a network 152.

Instream data are processed by an AI natural language processing (NLP) module 110 of the processing module 102 and subsequently stored in the storage module 106 as data fragments. The NPL module 110 includes an AI multimedia input processing unit configured to process instream data.

In one embodiment, the processing includes employing AI processing techniques to recognize and process instream data, which includes multimedia and numerical data. Multimedia data may include different content types, such as text content, numerical content, graphical content, image content, animations content, video or audio content or any other content types. An example of processing may include using NLP-enabled entity extraction to parse data containing text content. As for graphical content, the AI multimedia input processing unit may be configured to run any suitable external applications such as SnapChat or Camelot library, on the system to process the content. It is to be understood that it is common for one instream data to have one or multiple content types. For example, a webpage may include a combination of descriptive content (text), charts and images (graphics).

Additionally, in one embodiment, the system 100 is configured to handle instream data of different languages. For example, processing may also include determining a language type of the instream data.

In one embodiment, the processing further includes utilizing AI processing techniques to understand which part of the instream data contains meaningful data and to perform features extraction. The features may include quantitative or numeric features, for example, stock prices, capital gains, interest rates, revenues, or any other numeric features. Alternatively, non-numeric features that contain subjective information that is useful in risk evaluation may also be extracted. For example, in the case of suppliers, opinions and preferences of consumers may have a part in examining third party risk.

By enabling multimedia processing of instream data from diverse sources, the AI multimedia input processing unit allows the system to collect a comprehensive set of data As a result, the system can aggregate a pool of multivariate datasets which will be useful for the system to generate a more reliable risk evaluation. For example, in the case of commodities, it will be useful to combine conventional numerical data from internal financial reports together with multimedia data from weather reports since weather affects natural resources and can have a profound effect on the industry.

In one embodiment, the processing module 102 is configured to differentiate fake data in instream data. Fake data can be embedded within instream data such as news and reports, images or videos, and may not be easily detected unless additional efforts are taken to identify them. In one embodiment, after parsing of instream data 130, the processing module is configured to further process parsed incoming data to identify and separate fake data from being considered during computation of risk evaluation. The processing module may identify fake data based on audio signal processing, keywords and linguistic features that exhibit strong bias or misinformation, for example, by using a hyperbolic language, and web traffic (considering that fake news tends to attract a lot of attention).

The output platform 122 of the processing module 102 is configured to receive and process risk assessment requests and generate output data 132 as output reports. In one embodiment, the output module includes an output processing unit for processing risk assessment requests. A risk assessment request, for example, by a user 150, initiates a risk assessment computational workflow within the system. For example, a risk assessment workflow may include collecting data from sources and processing instream data by the processing module before the processed or parsed data is used for risk assessment computation by the AI finance-compute engine of the system. Results from the computational workflow are generated out by the output platform as output reports.

A risk assessment request, in one embodiment, may include a user 150 selecting a set of sources from which the system collects instream data. As discussed, the system may interact with a client device associated with the user via an App. The App allows the user to define and select a set of data sources to be streamed and processed by the AI risk assessment system for risk evaluation. By selecting a set of sources, the user has defined a scope of risk assessment, for example, user-defined risk assessment scope. Alternatively, data from any available sources can be automatically streamed into the AI risk assessment system via the network, for example, a machine-configured risk assessment scope.

A risk assessment scope determines types of data fragments extracted by the system as key parameters or features to compute risk assessment. As mentioned, a risk assessment scope may include a user-defined risk assessment scope or a machine-configured risk assessment scope. The output platform processes risk assessment requests, as well as user-defined risk assessment scope if there is any. Risk evaluation will be computed by the system based on data relevant to a risk assessment scope.

In one embodiment, the system 100 includes an AI finance-compute engine 104 coupled to the NLP module 110. The finance-compute engine 104 is configured to compute risk assessment using the multivariate datasets. Based on a risk assessment scope, the finance-compute engine extracts relevant key parameters or features from the multivariate datasets for computation.

In one embodiment, the finance-compute engine is trained using AI computational techniques to generate analytics for risk assessment. In one embodiment, the computational techniques can be machine learning (ML) or deep learning (DL) techniques. In one embodiment, any forms of supervised ML or DL techniques may be used.

Depending on what dependent-target factors or variables need to be addressed within the risk assessment scope, different types of analytical models or algorithms can be generated by the finance-compute engine. The analytical models or algorithms may include any forms of univariate, bivariate or multivariate models or algorithms. For example, a multivariate regression time series model can be generated to provide a multistep price action forecast involving multiple dependent variables. As for variables involving categories, for example, grouping different ranges of price movements into classes, a multiclass classification model can be used. In the case of credit risk which involves qualitative dependent-targets, a binary classification model can be used. Alternatively, the engine is also able to compute conventional univariate or bivariate time series models.

In other cases, the target variable for the risk assessment may be the probability of price action instead of the asset price movement. The probability may be expressed in binned percentages over a time period, such as the probability that it moves up/down 0-10%, 10-20%, or >20%. For example, a multiclass classification model is employed, based on the predicted probabilities, accept the scenario with the highest probability as most likely. Both the up and down expectations of price movement are flagged as opportunities. For example, opportunities may be to hold/acquire (up expectation) or sell/short (down expectation) the asset.

Analytics results are generated as output reports by the output platform. In one embodiment, the output reports may include conventional 2-dimensional (2D) risk reports and/or multimedia risk reports. For example, a conventional 2D risk report 150 may display various risk scores and findings. A multimedia risk report may include a video 154 that outlines multi-dimensional risk scoring considerations, and/or a display visualization model, for example, a 3D time series plot 152. This provides users or viewers with a more comprehensive understanding and explanation of displayed events which may not be easily conveyed using 2D displays.

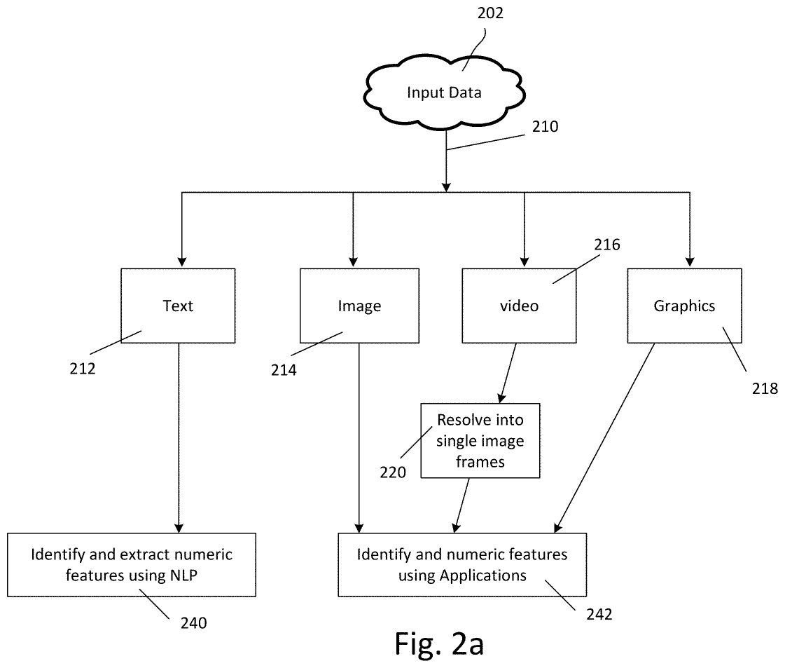

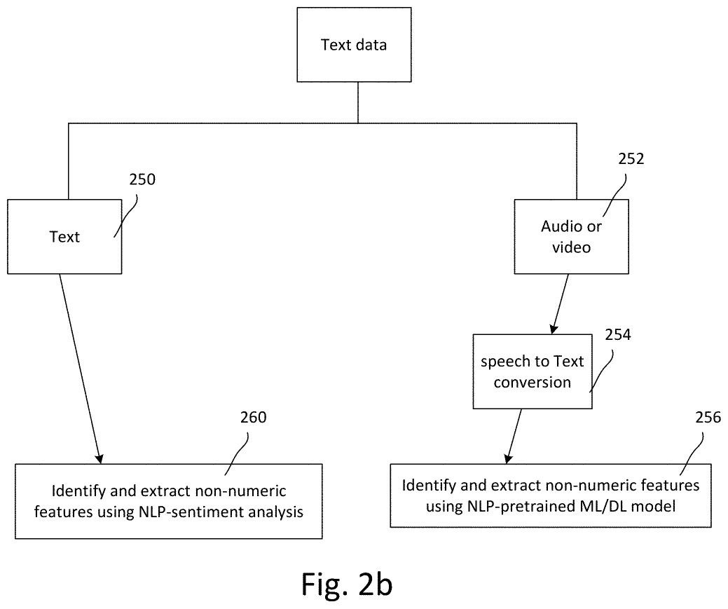

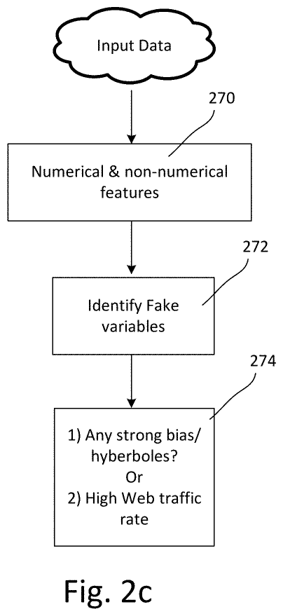

FIGS. 2a-c show various exemplary processes of an embodiment of a system architecture of an AI risk summarizer 100. As discussed, instream data are processed by an AI natural language processing (NLP) module of the processing module and subsequently stored in the storage module as data fragments. The NPL module includes an AI multimedia input processing unit configured to process instream data.

In one embodiment, the processing includes employing AI processing techniques to recognize and process instream data containing different content types. For example, multimedia data contains more than one content types. The different content types may include text content, graphical content, image content, animations content, video or audio content or any other content types. For example, graphical content may include charts, diagrams, graphs, tables or any other forms of graphics.

FIG. 2a shows an exemplary processing process of extracting numeric features from different content types in the instream data. In one embodiment, processing includes identifying at least one content type in the instream data. At 210, instream data 202 is processed to identify at least one content type in the instream data.

If text content is identified at 212, NLP-enabled entity extraction is employed to identify and extract numeric features in 240.

If graphical content is identified at 218 or image content at 214, NLP parsing is coupled with an image recognition unit to identify and extract numeric features using readily available applications at 242. In one embodiment, the image recognition unit is configured to utilize and run off-the-shelf applications on the system. For example, applications such as SnapCharts can be utilized for extracting numeric features from charts. As for tables, numeric features can be extracted using applications such as Camelot library.

If animations content is identified at 216, for example, a video, the video is first resolved into separate frames at 220. The separate frames are then treated as images and parsed using external applications run on the system, for example, SnapCharts or Camelot library for extracting numeric features from any charts or tables at 242.

The parsed incoming data are stored as data fragments, for example, numeric features, in the storage data. Other than extracting numeric features, the AI multimedia input processing unit is configured to extract subjective or non-numeric features, for example, sentiments, and classify them into binary or categorical features (positive, negative or neutral values).

In one embodiment, identified content types of the instream data are also processed by AI processing techniques to extract non-numeric features from the instream data. FIG. 2b shows how identified content in instream data is processed for extracting non-numeric features. Text content 250 is parsed using NLP-enabled sentiment analysis to extract non-numeric features or sentiments at 260.

Audios or animations content 252, such as videos, are first converted from speech to text at 254. The converted text is then parsed using NLP-enabled machine learning (ML) or deep learning (DL) techniques to recognize and extract sentiments at 256. In one embodiment, extracted sentiments may be further processed and classified into more meaningful data, for example, binary or categorical features (positive, negative or neutral values).

The parsed incoming data are stored as data fragments in the storage data. The data fragments include numeric features and/or non-numeric features such as sentiments. In one embodiment, as mentioned, the sentiments may be further processed and classified into more meaningful data, for example, binary or categorical features (positive, negative or neutral values). The data fragments form a pool of multivariate datasets which can be employed by the system to compute risk evaluation.

The pool of multivariate datasets will be useful for the system to generate a more reliable risk evaluation. For example, in the case of commodities, regular weather reports are important data, since the weather can affect resources and have a profound effect on the industry. As such, it will be useful to process weather data from commodity source as well as along the major shipping routes, since an adverse weather can disrupt distribution chain and cause price fluctuations.

Further, by employing AI-sentiment analysis, the system is able to collect subjective information, for example, popularity, preferences and behaviors of individuals who may affect an evaluation of risk. For example, in the case of evaluating third party risk for a supplier user, subjective information can be an important consideration.

In one embodiment, the processing module is configured to differentiate fake data in instream data. Fake data can be embedded within instream data such as news and reports, images and videos, and may not be easily detected unless additional efforts are taken to identify them.

FIG. 2c shows an exemplary process of identifying fake news from instream data. As previously discussed, instream data is processed and parsed by AI processing techniques to extract numeric and/or non-numeric features such as sentiments at 270. In one embodiment, the extracted features are further processed by the processing module to identify fake data at 272. Fake data can be determined by scanning for strong bias (for example, in language) or hyperbolics at 274. Additionally, at 274, the system may also check for high web traffic rate to determine for fake data since fake news tend to attract a lot of attention. Alternatively, other factors may also be used for consideration. Once fake data is identified, they are omitted from being used by the system for risk evaluation. In this case, the processing module serves to clean up the pool of datasets and allows the system to provide an accurate risk assessment that is well-aligned with actual financial markets events.

In one embodiment, the system includes an AI finance-compute engine coupled to the AI-NLP module. The finance-compute engine is configured to compute risk assessment using the multivariate datasets. Based on a risk assessment scope, the NLP module extracts relevant key parameters or features from the multivariate datasets and feeds to the finance-compute engine for computation.

In one embodiment, a risk assessment scope determines types of data fragments to be extracted by the system as key parameters or features to compute risk assessment. A risk assessment scope may include a user-defined risk assessment scope or a machine-configured risk assessment scope. For example, the system may interact with a client device associated with a user via an App. The App allows the user to define and select a set of sources from which data is collected and processed by the AI risk assessment system for risk evaluation. By selecting a set of sources, the user has defined a scope of risk assessment, for example, user-defined risk assessment scope. Alternatively, data from any available sources can be automatically streamed into the AI risk assessment system via the network and the system decides on the risk assessment scope, for example, a machine-configured risk assessment scope.

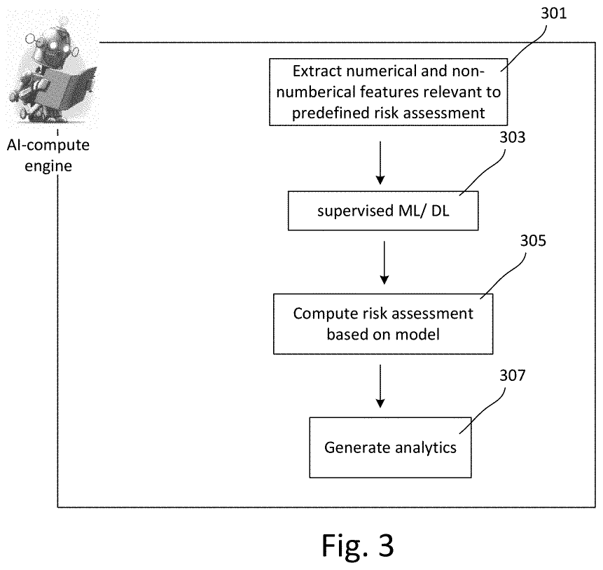

FIG. 3 shows an exemplary computational process by the AI finance-compute engine. At 301, the AI finance-compute engine extracts features based on a risk assessment scope. As discussed, a risk assessment scope may be a user-defined risk assessment scope or a machine-configured risk assessment scope. In one embodiment, the features include numeric and/or non-numeric features from multivariate datasets stored in the storage module.

The engine can be trained using AI computational techniques to generate analytics for risk assessment based on the risk assessment scope. As discussed, the computational techniques can be any form of supervised machine learning (ML) or deep learning (DL) techniques. In one embodiment, depending on what type of dependent-target factors or variables need to be addressed within the risk assessment scope, the system decides on appropriate ML or DL techniques. For example, for dependent-target variables in binary or categorical forms, multiclass classification techniques may be used. Linear or non-linear regression analysis may also be used for numerical variables.

In addition, the type of ML or DL techniques may also depend on a number of dependent-target factors or variables addressed within the risk assessment scope. Examples of analysis methods for different numbers of variables are univariate analysis, bivariate or multivariate analysis.

As shown in FIG. 3, at 303, the engine is trained using supervised ML or DL. Supervised ML or DL includes training the engine to generate one or more ML or DL models or algorithms based on the risk assessment scope. The one or more algorithms are then validated and tested with respective validating and testing data sets. In one embodiment, the NPL module manages the training of the finance-compute engine. The NLP module retrieves a data subset from the storage module and further splits the subset, into training, validating and testing data sets before providing them to the engine for training.

Once the algorithms are validated and tested for accuracy, the engine proceeds with computing the risk assessment at 305 by fitting the extracted features into the algorithms. For example, extracted features may be used as dependent or target variables of an algorithm. At 307, results of risk analytics are generated.

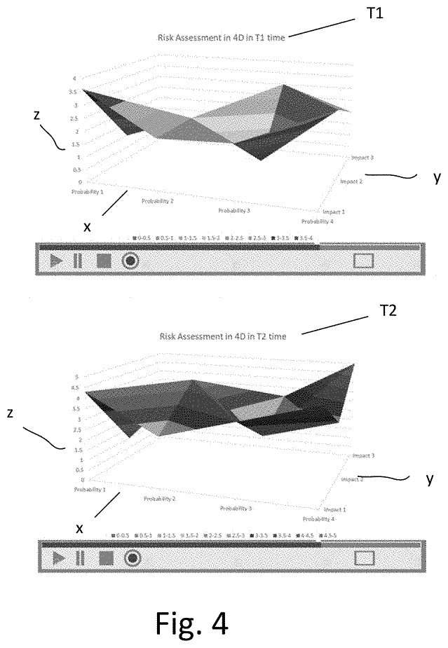

FIG. 4 shows various screenshots of a multimedia output report. In one embodiment, results of risk analytics are generated as output reports by the output platform. In one embodiment, the output reports may include conventional 2-dimensional (2D) risk reports and/or multimedia risk reports. For example, a conventional 2D risk report may display various risk scores and findings. A multimedia risk report may include a video or any other forms of multimedia reports.

In one embodiment, the video may display a visualization model in motion. For example, as seen in FIG. 4, the video displays a 3-dimensional (3D) graph. The 3D graph may illustrate 3 variables in 3 spatial dimensions (for example, x-, y-, z-dimensions). When the video is played, the video shows how the 3D graph changes from a first time period T1 to a second time period T2. By using moving motion to display how the 3 variables in the 3D graph changes with time, the video projects a 4D spatial view.

Additionally, the video may outline multi-dimensional risk scoring considerations. This provides users or viewers with a fast yet clear explanation of cause and effect as well as how changes develop over time.

In one embodiment, the video may address multiple topics related to risk assessment. For example, the video may include a series of topics such as listing of assets at risk, nominating threats to those assets, highlighting factors which affect the risk, as well as risk that needs to be avoided. By generating a matrix with the topics, a user viewer may consider various scenarios in the video. For example, one possible scenario may consider the potential threats and examine which assets would be adversely affected and the possible consequences. Or, alternatively, one may start with the assets and their exposure to potential threats and the consequence of each. Conversely, another scenario may begin with the consequences and identify what combination of assets and threats would lead to them.

A video may also be useful for explaining how each highlighted risk is cross affecting each other or they are independent. Further, by generating a video showing the continuous negative changes to the financial health of the company and by highlighting how the timing of each event is correlated, the user can quickly be informed on the key trigger events, e.g. that the company's management has been distracted with its new acquisition and has been unsuccessful in integrating its production and will likely face severe financial distress in the near future. This would be very meaningful for events which will not immediately be apparent and by its nature, will take some time to gestate.

In one embodiment, the system allows a user to define or tune display settings of the output. The settings may include types of results to be displayed, format to be displayed, or any other types of settings. For example, the system may include frontend components to facilitate running on a client device associated with a user. In practice, a user may download a frontend system to a client device associated with the particular user 151 as a computer application (App). An interface module of the App presents information output for display on a screen of the client device and allows the user to navigate the system 100 and interact with the components, modules, layers or digital content therein. For example, the interface module allows the user to define or tune the display settings of the output.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A method for market risk assessment comprising:
receiving instream data from different data sources;
processing the instream data, wherein processing the instream data comprises identifying one or more content types in the instream data and extracting features from the one or more content types to form a multivariate dataset;
computing risk analytics using the multivariate dataset; and
generating results of risk analytics as reports, the reports including multimedia reports, wherein the processing is configured to provide multimedia processing for a more meaningful and accurate risk evaluation.
